(19) United States
(12) Patent Application Publication
(10) Pub. No.: US 2004/0181904 A1
(43) Pub. Date: Sep. 23, 2004

(54) Foldable forcible entry tools

(76) Inventors: Gordon Steltzer, Kennebunkport, ME (US); Bruce Crampton, Sudbury, MA (US)

Correspondence Address: Bourque & Associates, P.A., Suite 301, 835 Hanover Street, Manchester, NH, 03104, US

(21) Appl. No.: 10/742,246

(22) Filed: Dec. 18, 2003

Related U.S. Application Data
(60) Provisional application No. 60/434,341, filed on Dec. 18, 2002.

(51) Int. Cl. E05B 7/00

(52) U.S. Cl. 16/110.1

(57) ABSTRACT

A collapsible tool includes at least one handle having first and second handle portions and hinge that allows the tool to benefit from the leverage and mechanical advantage of a full-size tool, yet is easily and quickly collapsible and extendable. In one embodiment, the first handle portion includes one or more spring-biased detents that contact engagement portions (preferably semi-circular surfaces) disposed on the second handle portion and secure the handle in the extended position. A pivot is disposed through the handle portions in the direction of the force moment produced during use. Alternatively, the first handle portion includes a base having three supports, a cavity, and a biased tab disposed within the cavity. The second end includes a bevel region and a notch region. In the extended position, the biased tab engages the notch region and secures the second handle portion between the biased tab and the supports.

### CROSS-REFERENCE TO RELATED APPLICATIONS

The application claims the benefit of U.S. Provisional Application Serial No. 60/434,341, filed Dec. 18, 2002, for the common subject matter.

### TECHNICAL FIELD

The present invention relates to emergency equipment, and, more particularly, relates to full size collapsible tools.

### BACKGROUND INFORMATION

In modern police and military work, especially among special weapons and tactics units as well as fire fighting and emergency rescue, it is necessary for such personnel to be able to gain access to buildings and structures quickly. To do so may require breaking a padlock, battering down a door, levering open a hatchway or any of a variety of techniques of forcible entry.

Complicating the task of forcible entry is the danger of opposition from within a structure: criminals or opponents may be firing weapons at personnel, making rapid entry even more important. As a result, personnel must be able to move rapidly, and to be relatively unencumbered by their equipment.

Heretofore the equipment used by such personnel, however, has historically been very large and heavy. The equipment must be full-size to allow the users to generate as much mechanical leverage and force as possible. If the equipment is simply made smaller and/or lighter, the users will not be able to generate enough force to, for example, break a padlock or cut a metal cable. Making the equipment smaller so as to be less cumbersome reduces the utility of such equipment, such as a sledge hammer. A smaller pry bar would have less leverage than a larger one, making it less useful.

A consequence of the need for full size equipment is that the equipment is very difficult to move and cumbersome. Often, individual personnel must separately transport each piece of equipment or at best can carry only two pieces of equipment. As a result, larger teams are required or not all of the available/necessary equipment can be taken on a mission. This problem is further complicated by the fact that such personnel often are required to transport a plethora of other heavy/bulky equipment such as weapons and body protection. As a result, personnel loaded down with the all the necessary equipment become much slower, less agile, and more apt to become the target of enemy aggression.

It is known in general to use telescoping handles to make tools such as snow brushes and the like smaller. However, many types of equipment, such as breaching tools, need to be strong, and are typically heavy so as both to provide strength and to add to their utility as discussed above. Often, such breaching tools are made with non-ferrous metals so that when breaching an area with combustible fumes in the air so as not to make sparks and possibly ignite the fumes. For example, a crack cocaine parlor utilizes potentially explosive quantities of ether.

It has been discovered that telescoping handles do not provide the necessary strength and rigidity necessary for certain types of equipment such as breaching tools, bolt cutters and the like. Under severe loads, the telescoping handles have been found to bend and/or break, thus rendering the equipment unsatisfactory and unserviceable. Moreover, in some circumstances, it has been discovered that telescoping handles do not allow the tools to be collapsed enough to be made mobile enough.

What is needed are breaching tools that have the necessary weight and size to be effective, yet are small enough so as not to interfere with the movement of personnel. The breaching tools must have a handle design, and in particular, a hinge design, that is capable of repeatedly withstanding the forces generated during normal use. What is further needed are breaching tools that can be easily carried by personnel yet are capable of being set-up and readily within moments even in low light conditions.

### SUMMARY

The present invention features a tool having at least one collapsible handle having a first and a second handle portion. The tool may include, but is not limited to, a lock buster, a bolt cutter, a battering ram, a pry bar, a hammer, or a shovel.

According to one embodiment, the first handle portion includes a first aperture disposed proximate a first end and a biased detent disposed a spaced distance towards a second end of the first handle portion. A spring preferably biases the detent towards an extended position.

The second handle portion includes a second aperture disposed proximate a first end, at least one contact region, and at least one engagement portion. The contact region is disposed proximate the first end of the second handle portion and is adapted to at least partially depress the biased detent when the handle is not extended. The engagement portion is preferably a semi-circular in shape and is sized to accept the biased detent such that when the first and the second handle portions are in an extended position, the biased detent engages the engagement portion thereby locking the first and the second handle portions relative to each other in the extended position. A pivot, preferably a pin having a first and a second head 351, is disposed through the first and the second apertures in the first and the second handle portions in an axis substantially parallel to a force generated during normal operation of the tool.

The second handle portion preferably includes a guidance bushing disposed proximate the first end. The guidance bushing preferably includes a first cavity having an aperture that corresponds to the first aperture in the first handle portion. Additionally, the guidance bushing includes a second cavity having apertures that correspond to the second aperture in the second handle portion.

According to another embodiment, the first handle portion includes a base, and a first, second, and at least a third support. The base is disposed proximate a first end of the first handle portion. The first, second, and third support extend outward from the base such that the first and the second supports extend outward further than the third support. A first and a second aperture disposed proximate a distal end of the first and the second supports, respectively.

A cavity is disposed within the base and includes at least one opening disposed between the first, the second, and the third supports. A biased tab is disposed within the cavity such that at least a portion of the biased tab extends through the opening in the cavity when the tool is not in an intermediary position. The biased tab preferably moves substantially parallel to a longitudinal axis of the first handle portion and preferably includes a lanyard.

The second handle portion includes a third aperture disposed a spaced distance from a first end of the second handle portion. A notch region is disposed proximate the first end of the second handle portion and at least one bevel region is disposed proximate the first end of the second handle portion beneath the notch region. The notch region may include an open top or a groove or channel.

A pivot is adapted to be disposed through the first, the second, and the apertures. When the handle is extended from a collapsed position into an extended position, the bevel region at least partially depresses the biased tab within the cavity. When the handle is in the extended position, the bevel region releases the biased tab and the biased tab is biased out of the cavity through the opening in the cavity and engages the notch region such that the first end of the second handle portion is disposed between the biased tab and the first, the second, and the third supports to form a rigid structure.

### BRIEF DESCRIPTION OF THE DRAWINGS

These and other features and advantages of the present invention will be better understood by reading the following detailed description, taken together with the drawings wherein:

FIG. 1 is a plan view of different tools according to the present invention;

FIG. 2 is a side view of one embodiment of the hinge shown in FIG. 1 according to the present invention in a partially collapsed position;

FIG. 3 is a side view of the embodiment of the hinge shown in FIG. 2 according to the present invention in an extended or locked position;

FIG. 4 is a exploded view of the embodiment of the hinge shown in FIGS. 2 and 3 according to the present invention;

FIG. 5 is another exploded view of the embodiment of the hinge shown in FIGS. 2 and 3 according to the present invention;

FIG. 6 is a cross sectional view of embodiment of the hinge shown in FIGS. 2 and 3 according to the present invention including a guidance bushing;

FIG. 7 is a plan view of a pair of bolt cutters in the extended position according to one embodiment of the present invention incorporating a hinge according to a second embodiment of the present invention;

FIG. 8 is a plan view of the pair of bolt cutters of FIG. 7 in the collapsed position;

FIG. 9 is a side view of another embodiment of the hinge shown in FIG. 1 according to the present invention in a partially collapsed position;

FIG. 10 is a side view of the hinge shown in FIG. 9 according to the present invention in an extended or locked position;

FIG. 11 is an exploded view of the hinge of FIGS. 9 and 10 according to the present invention;

FIG. 12 is a side view of yet another embodiment of the hinge shown in FIG. 1 according to the present invention in an partially collapsed position;

FIG. 13 is a side view of the hinge shown in FIG. 12 according to the present invention in an extended or locked position;

FIG. 14 is a side view of the hinge of FIGS. 9-13 according to the present invention in an intermediary or partially collapsed position; and

FIG. 15 is a cross sectional view of the hinge of FIGS. 9-13 according to the present invention showing the force distribution.

### DETAILED DESCRIPTION OF THE PREFERRED EMBODIMENTS

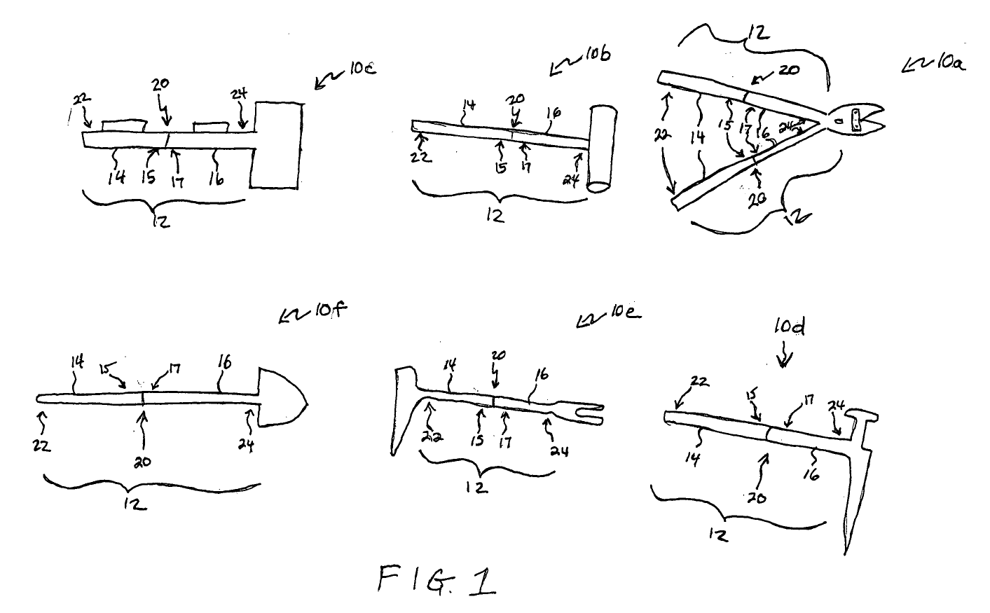

A tool 10, FIG. 1, according to the present invention, includes one or more handles 12 having a first and at least a second handle portion 14, 16 that allows the tool 10 to benefit from the leverage and mechanical advantage of a full size tool 10, yet is easily and quickly collapsible and extendable to permit a user to readily transport one or more tools 10 while still maintaining the desired degree of mobility. As will be understood by those skilled in the art, the exact type of tool 10 will, of course, depend upon the objective to be accomplished and is not intended to be a limitation of the present invention. For exemplary purposes only, and not intended to be a limitation of the present invention, the tool 10 may include a bolt cutter 10a, a hammer 10b, a battering ram 10c, a lock buster 10d, a pry bar 10e, a shovel 10f, or the like. The tools 10 are preferably constructed from high-strength metals, such as cast iron or steel, but may also be constructed from non-ferrous metals, titanium, plastics, or composites.

The first end 15, 17, of the first and second handle portion 14, 16 respectively are adapted to be connected to form the hinge 20 as will be discussed in great detail hereinbelow. The second ends 22, 24 of the first and second handle portion 14, 16 respectively will perform various functions depending on the specific tool 10.

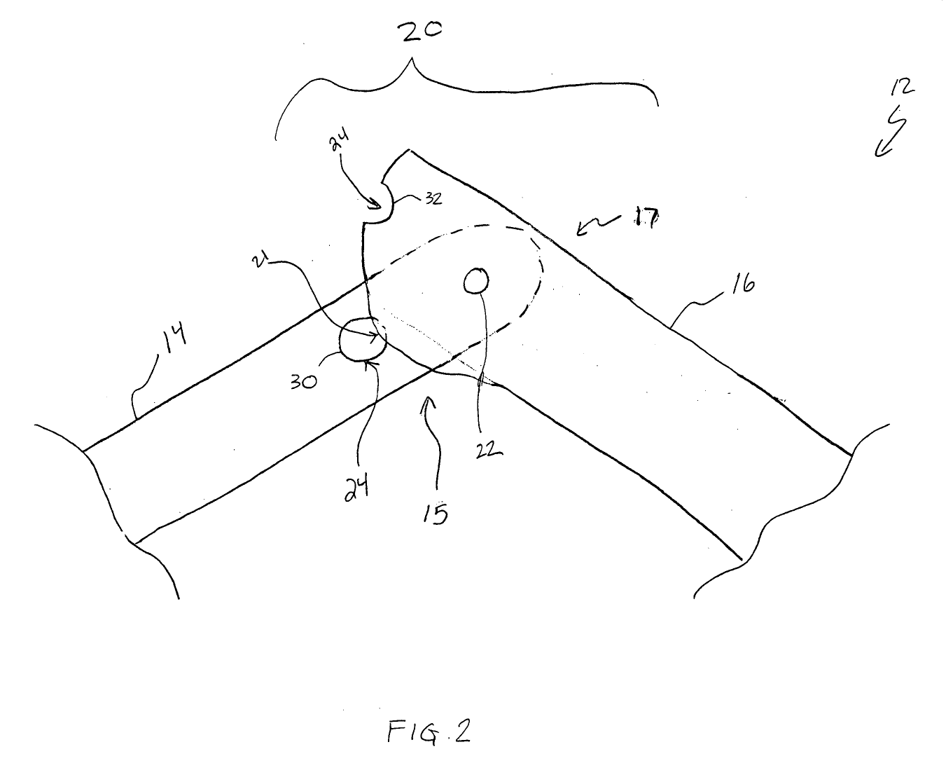

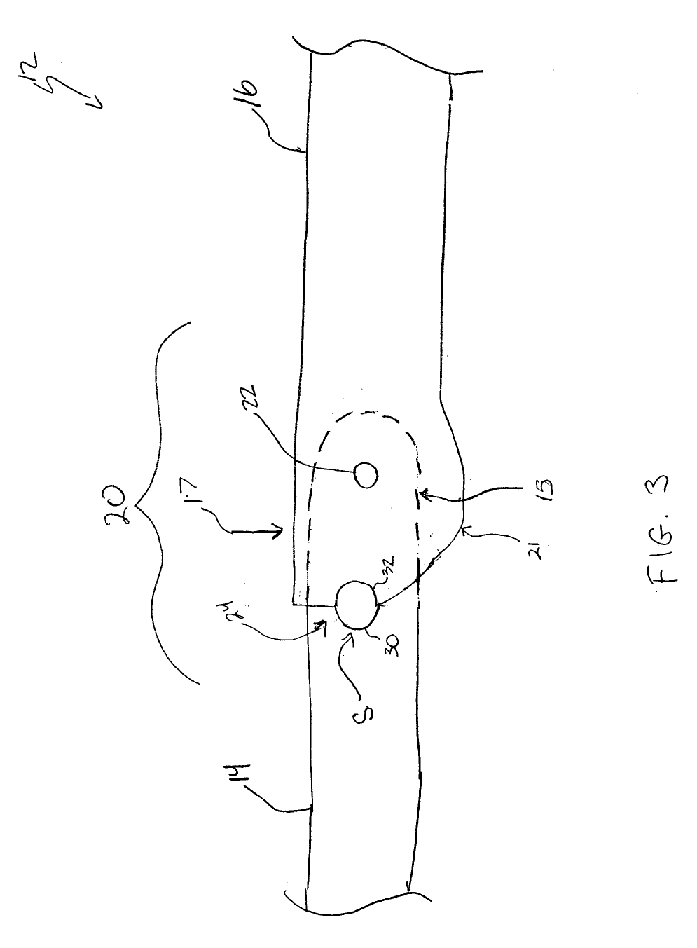

According to one embodiment, the handle assembly 12, FIG. 2, includes a first and a second handle portion 14, 15, shown in the “open” position relative to one another, wherein the hinge 20 includes a pivot 22 and a locking mechanism 24. The first and second handle portions 14, 16 are disposed about the pivot 22 such that one handle portion 14, 16 may rotate in a plane generally parallel with the longitudinal axis of the handle assembly 12. When in the extended position, as shown in FIG. 3, the locking mechanism 24 secures the first and the second handle portions 14, 16 about the pivot 22 so as to form a rigid handle assembly 12 capable of repeatedly withstanding the forces generated during use.

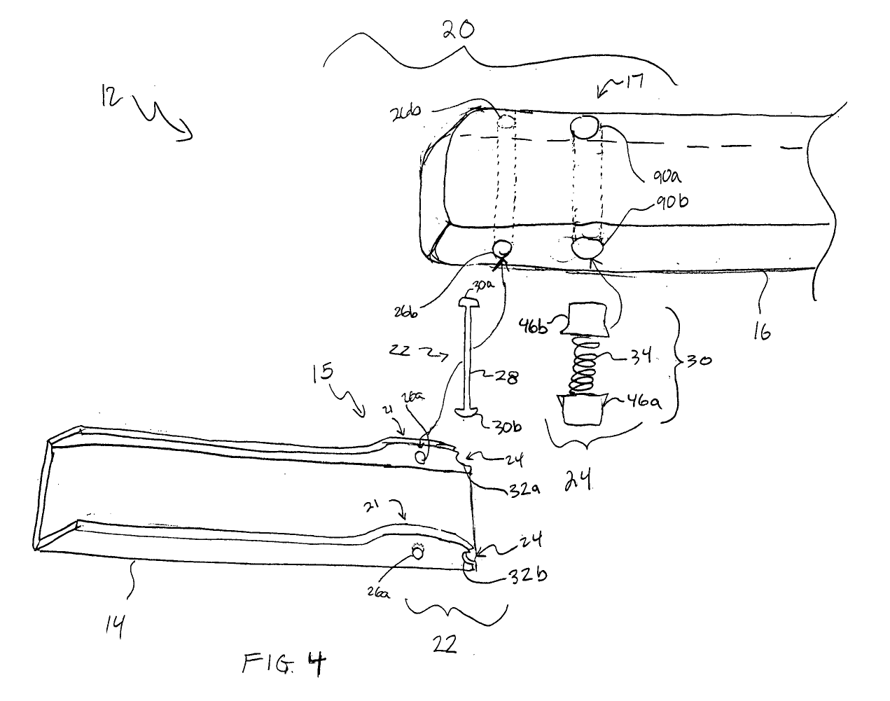

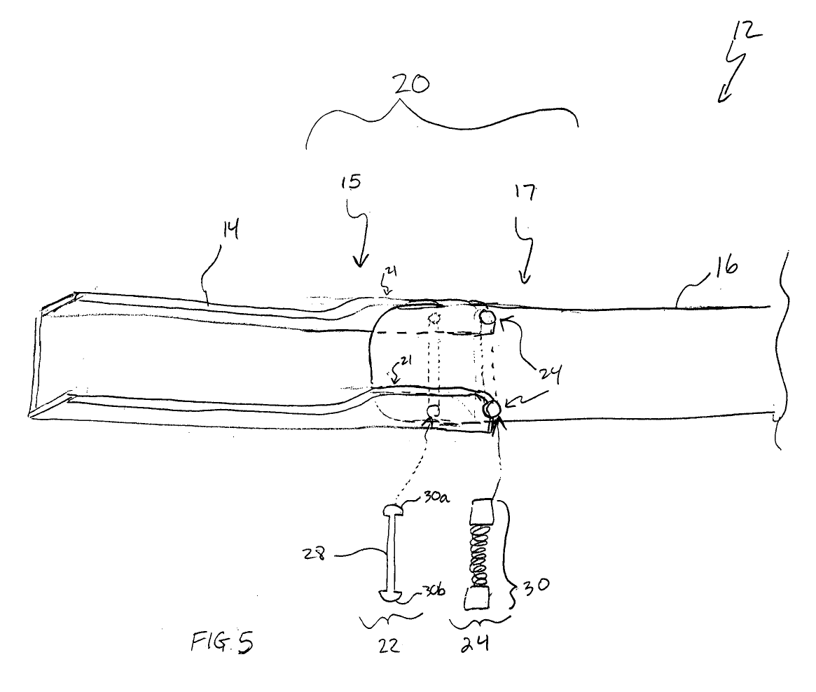

The pivot 22 is secured through apertures 26a, 26b, FIGS. 4, 5, disposed within the first ends 15, 17 of the first and second handle portions 14, 16 respectively. While the pivot 22 is shown as a pin 28 having a first and second head 30a, 30b, the exact design of the pivot 22 is not intended to be a limitation of the present invention. The pivot 22 may, for example, include bushings, washers, bearings, bolts, or the like. Alternative pivot designs not utilizing a pin 28, such as a bolt, rivet, etc., are also envisioned.

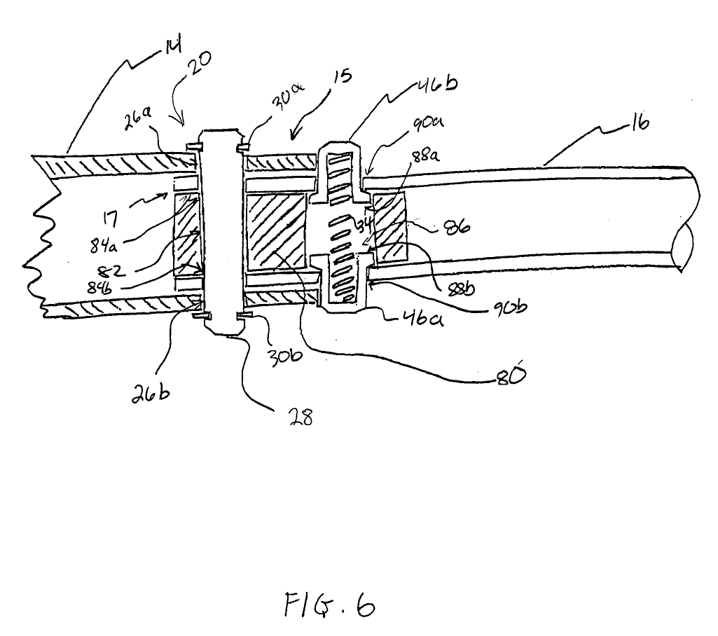

In the preferred embodiment, the second handle portion 16 includes a guidance bushing 80, FIG. 6, disposed inside and proximate the first end 17. The guidance bushing 80 includes a cavity 82 having apertures 84 corresponding to the apertures 26 in the second handle portion 16. The guidance bushing 80 increases the hinge assembly's 12 load capacity by transferring the force generated during use across a greater surface area.

The locking mechanism 24 includes a biasing mechanism 30 disposed within apertures 90 proximate the first end 17 of the second handle portion 16 and a plurality of engagement portions 32 disposed on the first end 15 of the first handle portion 14. When in the collapsed position, as shown in FIG. 2, contact region 21 preferably at least partially displace the biasing mechanism 30 within the first end 17 of the second handle portion 16. When in the extended position, as shown in FIG. 3, the biasing mechanism 30 is fully extended outward to contact the engagement portions 32 and thus form a fully extended rigid handle assembly 12.

The biasing mechanism 30, FIGS. 4 and 5, preferably includes a plurality of spring 34 biased detents 46. In the preferred embodiment, the guidance bushing 80, FIG. 6, includes a second cavity 86 having apertures 88. The apertures 88 correspond to the apertures 90 within the first end 17 of the second handle portion 16. The second cavity 86 reduces the likelihood of the detents 46 becoming jammed within the apertures 90 while the detents 46 are depressed.

As discussed hereinabove, the contact region 21, FIG. 2, at least partially depresses the detents 46 with the first end 17 of the second handle portion while the handle assembly 12 is in the collapsed position. When the handle assembly 12 is extended, the contact surfaces release the detents 46 and allow the detents 46 to engage the engagement portions 32 disposed on the first end 15 of the first handle portion 14 as shown in FIG. 3.

The engagement portions 32 preferably have a semi-circular shape, though other shapes such as, but not limited to, rectangles, triangles, ovals, and the like may also be utilized. The semi-circular shape has been found to facilitate the depression of the detents 46 by increasing the contact surface area S, FIG. 3, especially when a user is wearing gloves. Regardless of the shape of the engagement portions 32 and the corresponding shape of the detents 46, it is important that the handle assembly 12 is easily and quickly assembled and disassembled even in the dark and even with gloves on.

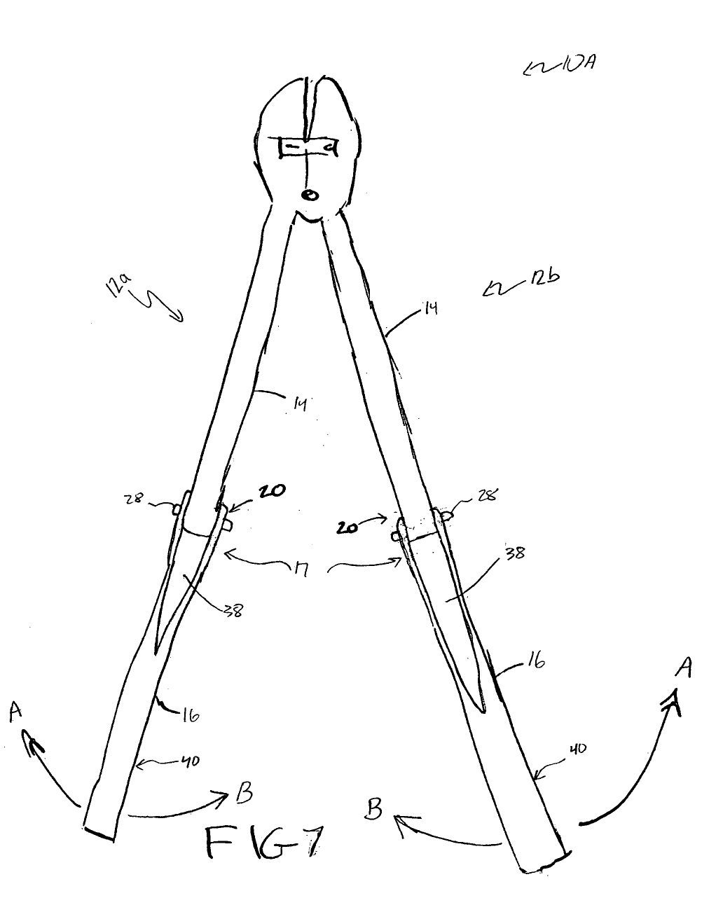

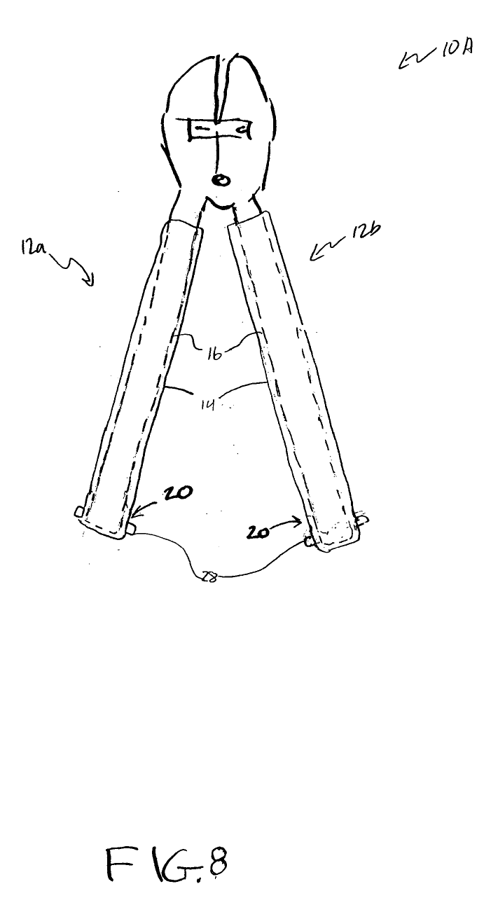

The orientation of the hinge 20, and in particular the orientation of the first and second handle portions 14, 16 relative to the tool 10 is very important and depends upon the specific tool 10. For exemplary purposes only, the present invention will be described as it relates to a bolt cutter 10a, FIGS. 7 and 8. However, as discussed hereinabove, the present invention may also include a hammer 10b, battering ram 10c, lockbuster 10d, pry bar 10e, or shovel 10f as will be understood by one skilled in the art.

The bolt cutter 10a, FIG. 7, is shown in the fully extended position. During normal use, the handles 12 move in the direction of arrows A and B. To open the bolt cutter 10a, the handles 12 are moved in the direction of arrows A. Most of the force, however, is generated when the bolt cutter 10a is closed (moved in the direction of arrows B). It has be discovered that positioning the pin 28 in the direction substantially in the same plane as arrows A and B (i.e. the direction that the greatest amount of force is generated in) allows substantially all of the moment force generated during use to be transmitted through the pin 28, and not the locking mechanism 24. As a result, the hinge assembly 20 is capable of repeatedly withstanding the force generated during use.

It has also been discovered that positioning the pin 28 in a plane substantially perpendicular to the arrows A and B (i.e. perpendicular to the direction the force is generated in) (not shown) results in the most of the moment force being transmitted through the locking mechanism 24. As a result, the locking mechanism 24 would have to be capable of withstanding the extreme force generated during use. However, design considerations such as, but not limited to, weight, complexity, and cost prevent traditional spring biased detents 30 from being capable of withstanding the force generated during use. As a result, traditional spring biased detents 30 will become deformed under normal use if most of the moment force is transmitted through the spring biased detents 30.

In the embodiment wherein the tool 10 is a bolt cutter 10a or the like, a benefit of positioning the pin 28 in the direction substantially in the same plane as arrows A and B is that the overall size when collapsed is smaller than if the pin was positioned such that the first handle portions 14 folded inward towards the center. In the preferred embodiment, the first end 17 of the second handle portions 16 further include a substantially “U” shaped or channel region 38, FIG. 7. The “U” shaped or channel region 38 allows the second handle portion 16 to fold around or nestle the first handle portion 15 while in the collapsed positioned as shown in FIG. 8 and allows the tool 10 to more compact when in the collapsed position. The exact size and shape of the channel region 37 will depend upon the size and shape of the tool 10 (as well as the desired degree of strength and compactability of the tool 10) and is within the knowledge of one of ordinary skill in the art. The second handle portion 16 also preferably includes a gripping region 40 disposed on proximate the distal end of the handle assembly 12.

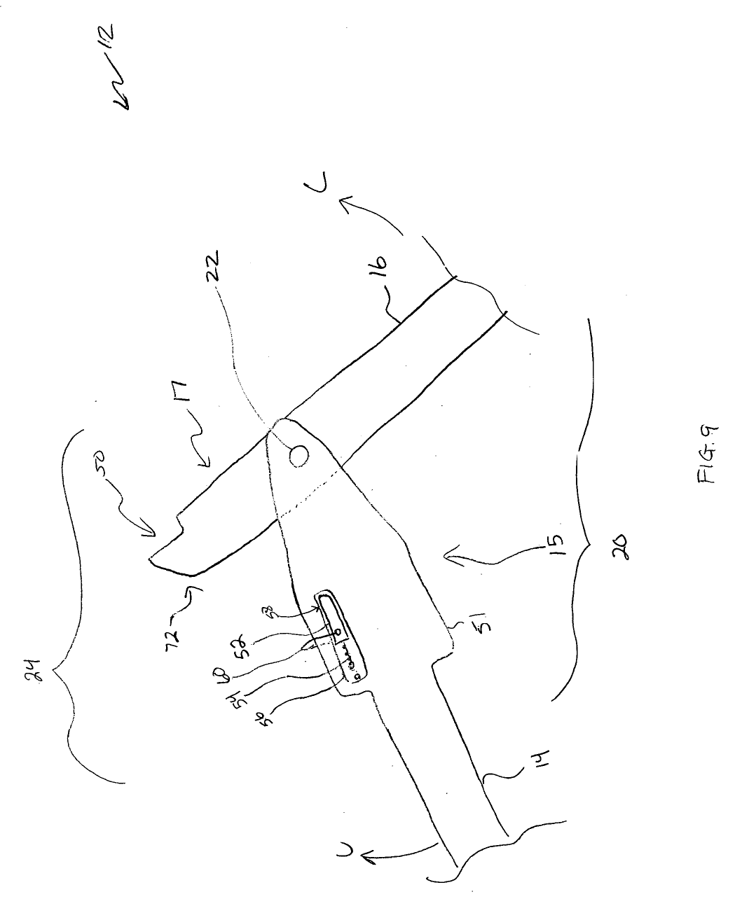

In another embodiment, the handle assembly 12, FIG. 9, includes a first and a second handle portion 14, 15, shown in the “open” position relative to one another, wherein the hinge 20 includes a pivot 22 and a locking mechanism 24 having a notch region 50 and a base 51 including a tab 52. The hinge 20 according to this embodiment is extremely strong and rigid, and is most suitable for use with, but not limited to, a pry bar 10e, shovel 10f, or hammer 10b, or any tool 10 wherein the handle 12 is subject to extreme force. As will be understood by one skilled in the art, the present embodiment of the hinge 20 may also be used with any tool 10 design.

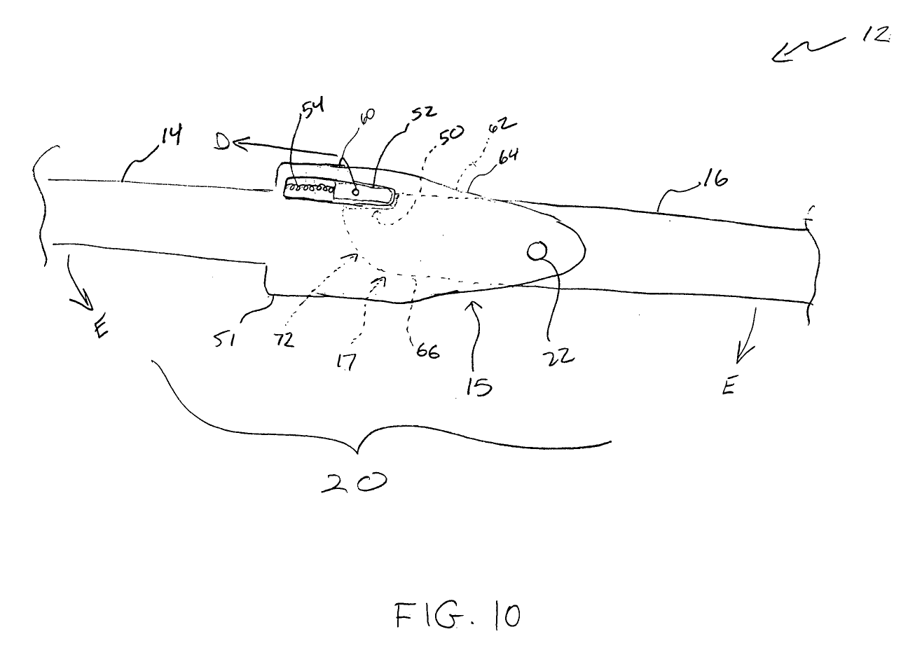

The base 51 may be disposed on the first end 15, 17 of either the first or second handle portion 14, 16. For exemplary purposes only, the hinge 20 will be discussed in the embodiment wherein the base 51 is disposed on the first handle portion 14. In the embodiment wherein the base 51 is disposed on the second handle portion 16, the handle assembly 12 is substantially the same except the elements are reversed. In the extended position as shown in FIG. 10, notch region 50 of the first end 15 of the second handle portion 16 is secured between the tab 52 and the three supports 62, 64, 66 as will be discussed in greater detail hereinbelow.

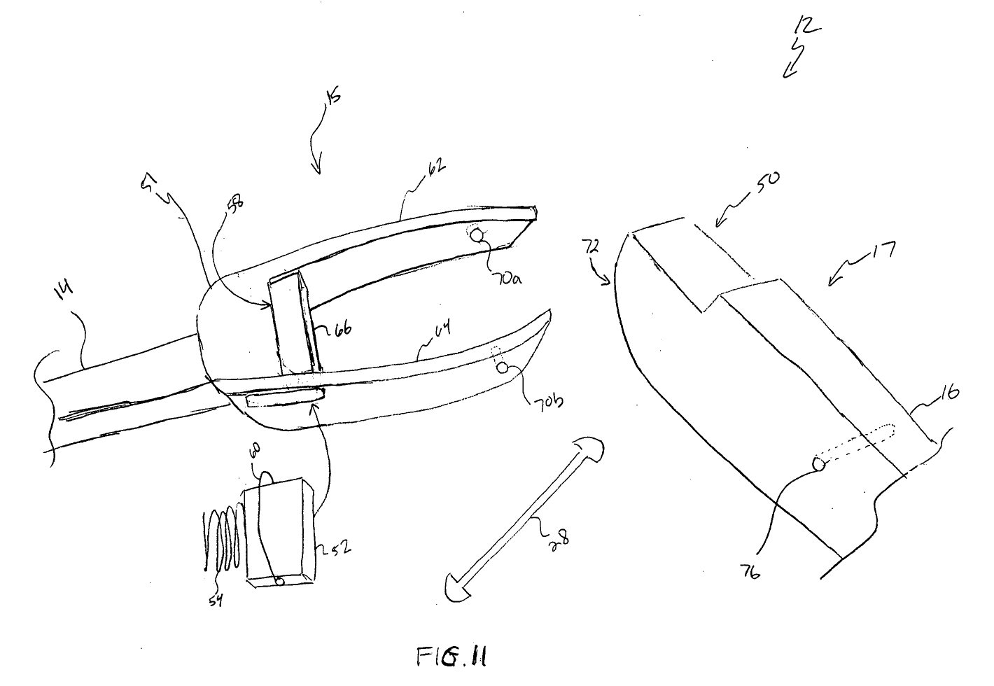

The base 51 includes a cavity 56 adapted to contain the tab 52. The tab 52 includes a lanyard 60, such as a piece of wire, cable, or the like, that facilitates a user, even while wearing gloves, to retract the tab 52 within the cavity 56 as will be discussed in greater detail hereinbelow. The cavity 56 includes at least one opening 58 (best shown in FIG. 11) and a spring 54 that biases the tab 52 towards the opening 58 such that at least a portion of the tab 52 extends through the opening 58 when the tab 52 is in the extended position.

Extending outward around the opening 58 and from the base 51 is the first, second, and at least a third support or base 62, 64, 66, FIG. 11. The first and second support 62, 64 are arranged substantially parallel to each other and are preferably longer than the third support 66 to allow the handle assembly 12 to collapse. In the preferred embodiment, the first and second support 62, 64 have an “arrow-head” or triangular shape, though may also be rectangular or oval in shaped.

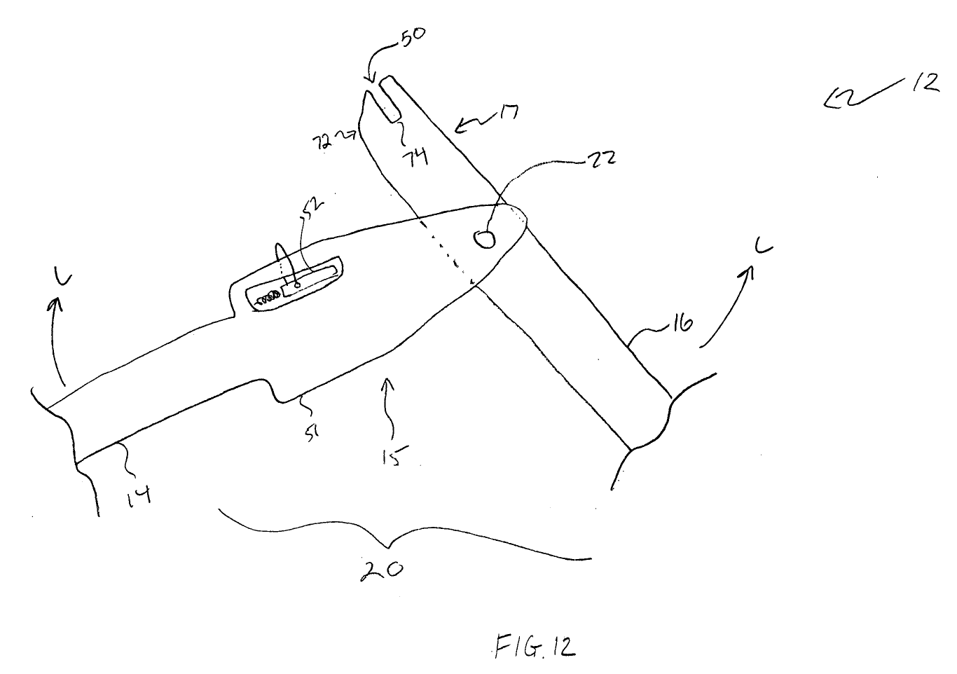

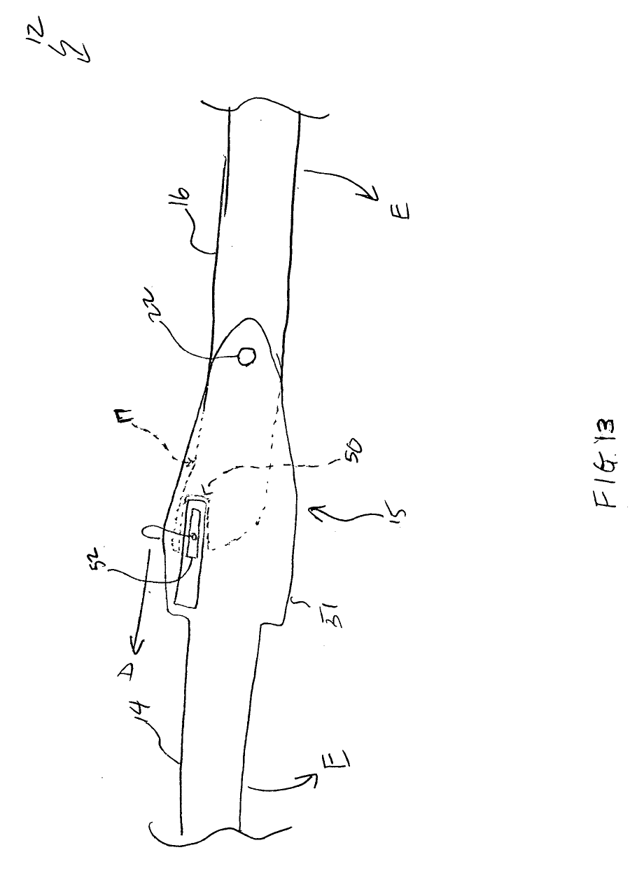

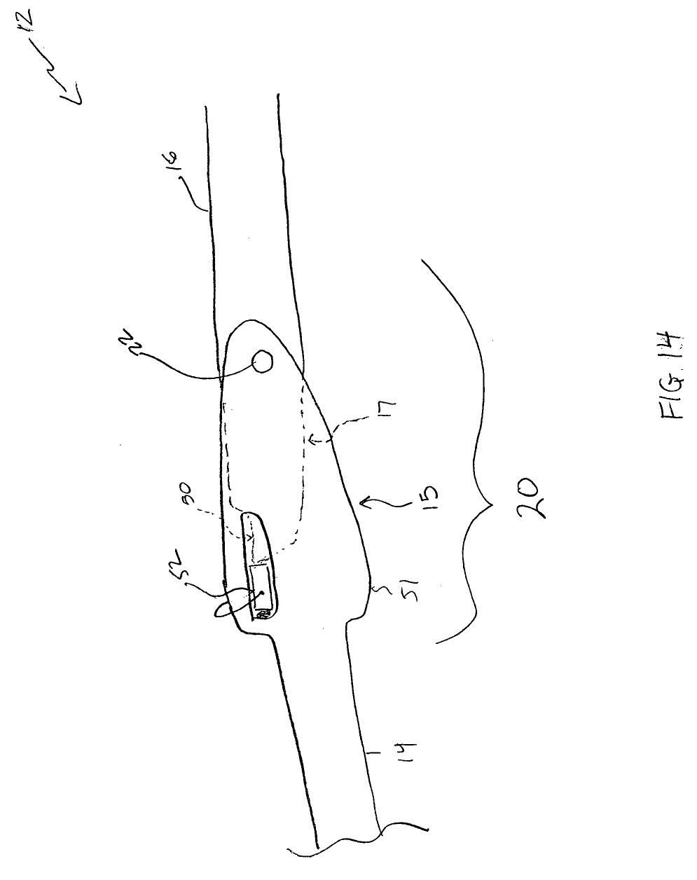

The notch region 50 is disposed on the first end 17 of the second handle portion 16 and is sized to accept the tab 52 when in the extended position as shown in FIG. 10. In the preferred embodiment, the notch region 50 includes an open top as shown in FIGS. 9-11. Alternatively, the notch region 50, FIGS. 12 and 13, may include a slot or notch 74 disposed proximate the distal end of the first end 17 of the second handle portion 16. According to this embodiment, the tab 52 slideably engages the slot or notch 74 as shown in FIG. 13. In either embodiment, the first end 17 also includes a beveled region 72. The beveled region 72 pushes the tab 52 into the retracted position as shown in FIG. 14.

The pivot assembly 22 includes apertures 70a, 70b disposed in the first and second supports 62, 64 and an aperture 76 disposed in the first end 17 of the second handle portion 16 sized to accept a pin 28. The pivot assembly 22 may include any pivot 22 design known to those skilled in the art including, but not limited to, pivots 22 having bearings, washers, bushings, and the like. The pivot assembly 22 must be constructed from a material and sized to repeatedly withstand the force generated during use. In the preferred embodiment, the pivot includes a pin 28 made from high-strength steel having a diameter of 0.25 inches.

While in the collapsed position (as shown in FIGS. 9 and 12), the tab 52 is in the extended position. To extend and lock the handle assembly 12, the user simply swings either the first or second handle portion 14, 16 in the direction of the arrow C. The bevel region 72 then makes contact with the tab 52 as shown in FIG. 14, pushing the tab 52 into the retracted position. Once the first and second handle portions 14, 16 are fully extended, the distal end of the first end 17 of the second handle portion 16 contacts the third support 66 and the spring 54 automatically forces the tab 52 into the notch region 50. As a result, the first end 17 of the second handle portion 16 is secured between the three supports 62, 64, 66 and the tab 52.

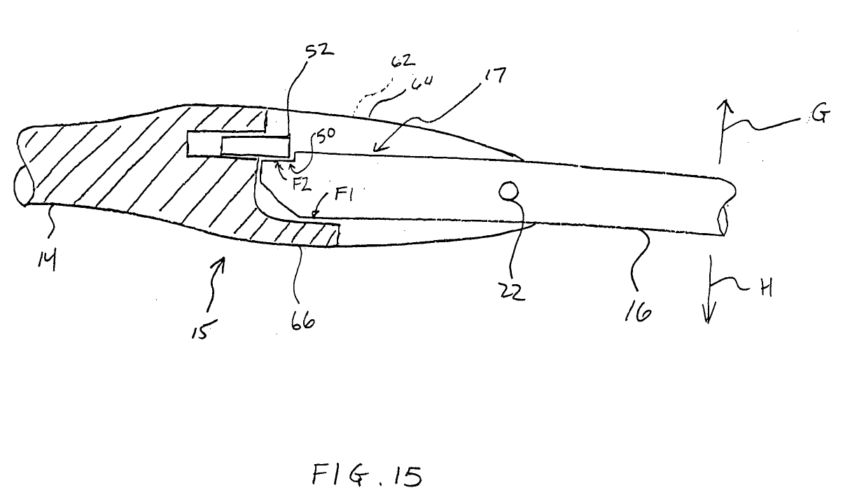

During normal use (for example when the second handle portion 16, FIG. 15, is moved in the direction of arrow G), substantially all of the force F1 is transmitted through the pivot 22 to the first and second supports 62, 64 as well through the first end 17 of the second handle portion 16 to the third support 66. Moreover, when the second handle portion 16 is moved in the direction of arrow H, substantially all of the force F2 is transmitted through the pivot 22 to the first and second supports 62, 64 and through the notch region 50 to tab 52. If the second handle portion 16 is moved in a direction perpendicular to arrows G and H, then the force is transmitted through the pivot 22 and the first or second supports 62, 64. As a result, the hinge assembly 12 is capable of withstanding extremely high forces in any direction relative to traditional hinge designs.

To collapse the handle assembly 12, FIG. 13, the user simply pulls on the lanyard 60 in the direction of the arrow D forcing the tab 52 into the retracted position and releasing the notch region 50 and allowing the user to move the first and second handle portion 14, 16 in the direction of the arrow E. In the preferred embodiment, the tab 52 moves substantially parallel to the longitudinal axis of the first handle portion 14. Alternatively, the tab 52 may also move in a direction at an angle relative to the longitudinal axis.

Modifications and substitutions by one of ordinary skill in the art are considered to be within the scope of the present invention.

The invention claimed is:

1. A tool having at least one handle comprising:
a first handle portion having a first aperture disposed proximate a first end and a biased detent disposed a spaced distance towards a second end of said first handle portion;
a second handle portion having:
a second aperture disposed proximate a first end of said second handle portion;
at least one contact region disposed proximate said first end of said second handle portion, said contact region adapted to at least partially depress said biased detent when said at least one handle is not extended; and
at least one engagement portion sized to accept said biased detent such that when said first and said second handle portions are in an extended position, said biased detent engages said engagement portion thereby locking said first and said second handle portions relative to each other in said extended position; and
a pivot adapted to be disposed through said first and said second apertures in said first and said second handle portions wherein said pivot is disposed in an axis substantially parallel to a force generated during normal operation of said tool.

2. The tool as claimed in claim 1 wherein said biased detent includes a spring biasing said detent towards an extended position.

3. The tool as claimed in claim 1 wherein said pivot includes a pin having a first and a second head.

4. The tool as claimed in claim 1 wherein said engagement portion includes a semi-circular shape.

5. The tool as claimed in claim 1 wherein said tool includes a lock buster.

6. The tool as claimed in claim 1 wherein said tool includes a bolt cutter

7. The tool as claimed in claim 1 wherein said tool includes a battering ram.

8. The tool as claimed in claim 1 wherein said second handle portion further includes a guidance bushing disposed proximate said first end.

9. The tool as claimed in claim 8 wherein said guidance bushing includes a first cavity having an aperture that corresponds to said first aperture in said first handle portion.

10. The tool as claimed in claim 9 wherein said guidance bushing further includes a second cavity having apertures that correspond to said second aperture in said second handle portion.

11. A tool having at least one handle comprising:
a first handle portion having:
a base disposed proximate a first end of said first handle portion;
a first, second, and at least a third support extending outward from said base such that said first and said second supports extend outward further than said third support;
a first and a second aperture disposed proximate a distal end of said first and said second supports, respectively;
a cavity disposed within said base having at least one opening disposed between said first, said second, and said third supports; and
a biased tab disposed within said cavity such that at least a portion of said biased tab extends through said opening in said cavity when said tool is not in an intermediary position;
a second handle portion having:
a third aperture disposed a spaced distance from a first end of said second handle portion;
a notch region disposed proximate said first end of said second handle portion; and
at least one bevel region disposed proximate said first end of said second handle portion beneath said notch region; and
a pivot adapted to be disposed through said first, said second, and said apertures whereby as said handle is extended from a collapsed position into an extended position, said bevel region at least partially depresses said biased tab within said cavity and whereby when said handle is in said extended position, said bevel region releases said biased tab and said biased tab is biased out of said cavity through said opening in said cavity and engages said notch region such that said first end of said second handle portion is disposed between said biased tab and said first, said second, and said third supports to form a rigid structure.

12. The tool as claimed in claim 11 wherein said biased tab includes a spring.

13. The tool as claimed in claim 11 wherein said biased tab moves substantially parallel to a longitudinal axis of said first handle portion.

14. The tool as claimed in claim 11 wherein said tab includes a lanyard.

15. The tool as claimed in claim 11 wherein said notch region includes an open top.

16. The tool as claimed in claim 11 wherein said notch region includes a groove or channel.

17. The tool as claimed in claim 11 wherein said tool is a pry bar.

18. The tool as claimed in claim 11 wherein said tool is a hammer.

19. The tool as claimed in claim 11 wherein said tool is a shovel.

20. The tool as claimed in claim 11 wherein said pivot includes a pin having a first and a second head.
